(19) United States
(12) Patent Application Publication
(10) Pub. No.: US 2004/0042035 A1
(43) Pub. Date: Mar. 4, 2004

(54) Image forming system and back-end processor

(75) Inventor: Hiroyoshi Uejo, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/386,423

(22) Filed: Mar. 13, 2003

(30) Foreign Application Priority Data
Aug. 29, 2002 (JP) 2002-250331

(51) Int. Cl. G06F 3/12; G06F 15/00; G06F 13/00; G06K 15/02

(52) U.S. Cl. 358/1.15; 358/1.18

(57) ABSTRACT

A printing control portion 620 for controlling an engine 30 in accordance with the processing characteristics of the engine 30 is removed from the FEP 500, so that the FEP 500 can exclusively perform the RIP processing or compressive processing. The printing control portion 620 removed from the FEP 500 is relocated in a BEP 600 closely connected to the output side. An image storage portion 602 for storing data received from the FEP 500 is provided in the BEP 600. To perform processing suitable for the output format in accordance with a request from a client or recovery processing, the BEP 600 controls each functional portion in the BEP 600 or the printing engine 30 on the output side, independent of the FEP 500, so as to perform processing in accordance with the output format desired by the client or the recovery processing, and then send image data to the printing engine 30.

### BACKGROUND OF THE INVENTION

The present invention relates to an image forming system that comprises an image forming apparatus having a so-called printing function for forming images on a recording medium such as color copiers, facsimiles, or printers and a back-end processor that constitutes the image forming system.

An image forming apparatus having printing function such as printers or copiers are employed in various fields. In recent years, those image forming apparatuses are provided with color printing capabilities and thereby employed to meet user requirements for various expressions. For example, color page printers employing the electro-photography process (xerography) receive widespread attention focused on their high-quality images and high-speed printing.

On the other hand, from the viewpoint of the printing function, those image forming apparatuses are largely divided into two types: one, such as for personal use at home or business use in an office, requiring a relatively small-scale printout capability (e.g., several to several tens of sheets of paper per one job) and the printing industry in bookbinding, etc., requiring a relatively large-scale printout capability (e.g., several thousands of sheets of paper per one job). Most of the former apparatuses (e.g., except the screen printing), of which required is a relatively small-scale printout capability, receive print data to deliver printouts without creating any artwork. On the other hand, the latter, of which required is a relatively large-scale printout capability, creates artwork in accordance with print data to deliver printouts using the artwork created.

However, in recent years, the printing process is changed due to the widespread use of DTP (Desk Top Publishing/Prepress) or the so-called “digital innovation in printing.” That is, attention is focused on “direct printing” by which printing is performed directly from DTP data or “on-demandprinting.” This on-demand printing employs a CTP (Computer to Print or Paper) scheme for delivering printouts in accordance with electronic data by completely digitizing the pre-press step without creating any intermediate products in conventional printing (e.g., offset printing), for example, printed photographic paper such as by photo typography, artwork, halftone negative, halftone positive, or PS print. Thus, a printing function employing the electro-photography process receives attention for the requirements of on-demand printing.

FIG. 5 is a schematic view illustrating a prior art image forming system. FIG. 5A is a view illustrating the entire configuration of the system, FIG. 5B being a view illustrating a data flow.

As shown in FIG. 5A, the image forming system comprises an image forming apparatus 1, and a DFE (Digital Front End Processor) or a terminal device that passes print data to the image forming apparatus 1 and directs printing thereto.

The image forming apparatus 1 makes use of the electro-photography process to record images on a predetermined recording medium, comprising an IOT (Image Output Terminal) module 2, a feed (paper feed) module (FM=Feeder Module) 5, an output module 7, a user interface 8, and a coupling module 9 for coupling the IOT module 2 to the feed module 5.

The DFE comprises a drawing function and a printer controller function. The DFE receives sequential print data described such as in PDL (Page Description Language) from a client terminal device (not shown), and then converts the print data into raster image (RIP processing process=Raster Image Process) Subsequently, the DFE sends the image data processed through RIP processing and print control information (job ticket), such as the number of prints and the size of the paper, to the image forming apparatus 1. The DFE thus controls the printing engine of the image forming apparatus 1 or the paper feed system so that the image forming apparatus 1 performs printing. That is, the printing operation of the image forming apparatus 1 is controlled by means of the printer controller of the DFE.

The image forming apparatus 1 receives, as print data, fundamental colors for color printing, that is, yellow (Y), cyan (C),magenta (M), and black (K) (hereinafter referred to as “YMCK” for short).

The user interface 8 supports easy-to-understand dialogues between the operator and the image forming apparatus 1. To provide improved operability, the user interface 8 comprises a color display 8a incorporating a touch panel and a hard control panel 8b arranged beside it, which are supported on support arms 8c on a base machine (the main body or the coupling module 9 in this example) as shown in the figure.

The IOT module 2 has an IOT core portion 20 and a toner supply portion 22. The toner supply portion 22 is adapted to incorporate toner cartridges 24 for use with YMCK for color printing.

The IOT core portion 20 comprises printing engines (printing unit) 30 each having an optical scanner 31 and a photosensitive drum 32 for each of the aforementioned color components. The printing engines 30 are configured in tandem with each other or arrayed in a row in the belt rotational direction. The IOT core portion 20 comprises an electric control system housing 39 for housing an electric circuit for controlling the printing engine 30 or a power supply circuit for use with each module.

To transfer images, the IOT core portion 20 transfers a toner image on the photosensitive drum 32 onto an intermediate transfer belt 43 by means of a primary transfer device 35 (primary transfer). Thereafter, a secondary transfer portion 45 transfers the toner image on the intermediate transfer belt 43 onto a print sheet (Secondary transfer). With this arrangement, each color toner of YMCK is used to form the image on each of the photosensitive drums 32, the toner image being then transferred in multiple onto the intermediate transfer belt 43.

The image transferred onto the intermediate transfer belt 43 (the toner image) is transferred onto a sheet fed from the feed module 5 at predetermined time intervals. The sheet is then transported to a fuser 70 along a second transport path 48, where the toner image is melted and fused on the sheet by the fuser 70. Thereafter, the sheet is temporarily held in an exit tray (stacker) 74 or intermediately passed to a sheet releaser 72, being allowed to exit the system after completing processing if necessary. For two-sided printing, a printed sheet is extracted from the exit tray 74 to an inversion path 76, being passed to an inversion transport path 49 of the IOT module 2.

As described above, after having received print data described in the Page Description Language (PDL) from the client terminal device, the DFE on the input side interprets the PDL to create image data of each page, which is in turn sent to the image forming apparatus 1 on the output side. In general, rendering is performed on the entire image data for each one output (typically one page) before outputting the image. The IOT module 2 on the output side and the output module 7 perform printing operation (image forming operation) synchronous to the printing engine 30 and the fuser 70 in accordance with the image data received in page units under the control of the front end processor.

On-the other hand, in recent years, there are growing demands for higher performance and higher speeds in image formation processing (printing). To meet these demands for higher performance and higher speeds, an image forming apparatus is suggested which incorporates a high-speed and high-performance CPU. The image forming apparatus enables high-speed control by making use of the speed of the printing engine and supports total productivity ranging from printing directions to print output for high-speed color printing, e.g., 100 to 200 sheets/minute or more.

On the other hand, to operate such a high-speed and high-performance image forming apparatus, it is necessary not only to improve the image forming apparatus but also to provide a high-speed and high-performance printer controller which serves as a printing control portion for controlling RIP processing and the image recording portion on the output side.

However, a DFE having the conventional front-end processor function cannot be coupled to the image forming apparatus to meet the aforementioned demands. For example, the prior art DFE is adapted to perform not only RIP processing on the PDL data received from a client terminal device but also additional processing such as page rearrangement according to printing jobs (such as sorting in ascending or descending order, determination of the order of pages for two-sided printing, and relocation for finishers) or data conversion according to the processing characteristics of the printing engine and the fuser on the output side (such as calibration of gray balance or color shift).

It is therefore necessary to generate image data (or video data) processed through RIP processing in accordance with the characteristics of the image forming apparatus, perform high-level processing in accordance with the characteristics of the printing unit, or provide sync control to the drive portion. This made the DFE and the image forming apparatus substantially inseparable from each other. Electric signals were transmitted between the DFE and the image forming apparatus 1 through dedicated connection interfaces using a dedicated communications protocol.

Thus, while using a general-purpose RIP engine, DFEs are independent of one another, thereby raising problems of an increase in man-hours for development of DFEs and creating a need for users to purchase DFEs according to their types.

However, since the DFE and the image forming apparatus 1 are closely related to each other as described above, the higher the speed of the image forming apparatus, the heavier the loads for generating image data processed through RIP processing in accordance with the characteristics of the image forming apparatus and for providing control to the output side. This makes it difficult to provide higher speed processing capability to the DFE.

Additionally, an image forming apparatus (image forming system) with improved operating speeds would cause the DFE to bear the burden of performing the RIP processing and providing control dependent on the processing characteristics of the output side in parallel, thereby raising a problem of being incapable of operating at higher speeds.

For example, the following types of processing may be required. That is, these types of processing include processing, suitable for the output format in accordance with the request by a client, e.g., positioning processing such as rotation, collation and two-sided printing, related to the finisher (e.g., the stamp, punch, and stapler) or the sheet tray: calibration processing such as adjustment of paper exit face adjustment and correction of gray balance and color shift; and screen designation. Furthermore, included is the processing, which is dependent on the processing characteristics of the image forming apparatus 1 on the output side (e.g., the printing engine), such as the recovery processing for coping with output jamming (paper jamming).

In this case, it is necessary for the DFE to provide control to the output side based on thorough knowledge of the engine characteristics or know-how, or in some cases regenerate image data to transfer the resulting data to the back-end processor. Thus, a DFE equipped with a general-purpose RIP engine suffers from a significant burden of processing and needs a significantly long time for the processing.

For example, such a system is being suggested which has a RIP processing equipped with a high-speed and high-performance CPU to provide color prints of 100 to 200 sheets per minute or more. However, in the cases where the processing dependent on the processing characteristics of the output side is required such as processing suitable for the output format in accordance with the request of a client or recovery processing, the systems will bear the burden of controlling the RIP processing output side in parallel, thereby making it impossible to make full use of the potential capabilities thereof.

### SUMMARY OF THE INVENTION

The present invention is developed in view of the aforementioned problems. It is therefore a first object to provide an image forming system that is capable of flexibly expanding the performance and improving the speed of the system.

Furthermore, it is a second object of the present invention to provide a back-end processor that constitutes the image forming system capable of flexibly expanding the performance and improving the speed of the system.

That is, a first image forming system according to the present invention comprises a front-end process or having an image data generation portion for generating image data of each page by processing a printing job; and aback-end processor, provided corresponding to an image recorder portion for recording an image on a predetermined recording medium, for receiving image data of each page from the front-end processor, sending the image data to the image recorder portion, and controlling the image recorder portion. The front-end processor generates the image data independent of the image recorder portion.

Furthermore, the first image forming system according to the present invention is provided with the back-end processor that comprises an image storage portion for receiving and storing image data processed by the front-end processor independent of the image recorder portion and an output format information acquisition portion for receiving information related to an output format desired by a client. The back-end processor further comprises a printing control portion for providing control to each functional portion in the back-end processor so as to read the image data from the image storage portion, perform processing dependent on the image recorder portion and the output format desired by the client indicated by the information acquired by the output format information acquisition portion, and then send the image data to the image recorder portion.

A second image forming system according to the present invention comprises a front-end processor having an image data generation portion for generating image data of each page by processing a printing job; and a back-end processor, provided corresponding to an image recorder portion for recording an image on a predetermined recording medium, for receiving image data of each page from the front-end processor, sending the image data to the image recorder portion, and controlling the image recorder portion. Like the first image forming system, the front-end processor generates the image data independent of the image recorder portion.

Furthermore, the second image forming system according to the present invention is provided with the back-end processor that comprises an image storage portion for receiving and storing image data processed by the front-end processor independent of the image recorder portion. The back-end processor further comprises a printing control portion for providing control to each functional portion in the back-end processor so as to read the image data from the image storage portion, perform processing dependent on the image recorder portion, and then send the image data to the image recorder portion, and to perform recovery processing of output jamming dependent on the processing characteristics of the image recorder portion when an output jamming phenomenon is occurred during processing of the printing job.

In the foregoing, the image recorder portion is a generic name for the functional portions related to the image forming operation regarding the job instructed by a client. The typical functional portions contained in the image recorder portion include a printing engine, fuser, transport member for transporting recording media, or finisher.

Furthermore, in the foregoing, the “processing independent of the image recorder portion” does not necessarily mean to be perfectly independent of the image recorder portion or the back-end processor for controlling the image recorder portion. It also means that image data is generated to a certain extent of freedom generally independent thereof without being strongly restricted by the image recorder portion the back-end processor (generally independent of the processing speed of the image recorder portion).

Furthermore, in the foregoing, the processing dependent on the image recorder portion may be image processing performed on the image data itself or predetermined processing performed on each portion of the apparatus to obtain a desired output image. In the former case, the printing control portion provides control so as to transmit processed image data to the image recorder portion.

In the present invention, the processing characteristics of the image recorder portion may be related at least to one of these functional portions. In particular, the present invention can be effectively applied to the printing engine employing the electro-photography process in relation to the printing engine or the fuser.

Furthermore, “controlling each functional portion in the back-end processor” means to control each functional portion in the back-end processor so as not to impose any burden on the front-end processor irrespective of the front-end processor. This means that the image recorder portion can perform the printing processing.

That is, upon performing the processing suitable for the output format based on the request by a client or recovery processing, the image data is sent to the output side after each functional portion of the back-end processor and the output side such as the printing engine or the fuser are controlled irrespective of the front-end processor to perform the processing in accordance with the output format desired by the client or recovery processing. At this stage, when the RIP processing has to be re-performed, such processing is carried out corresponding to each functional portion in the back-end processor without requesting the front-end processor to re-perform the RIP processing.

The back-end processor according to the present invention is a back-end processor (mainly consisting of the printing control function) suitable for constituting the aforementioned first or the second image forming system, comprising the functional portions described in the aforementioned system.

The inventions set forth in the dependent claims specify more advantageous implementation examples for the image forming system or the back-end processor according to the present invention.

In the image forming system configured as described above, the front-end processor has an image data generation function but no printer controller function for providing control dependent on the output side. The printer controller function for providing control dependent on the output side is provided on the back-end processor. The front-end processor sends the generated image data to the back-end processor independent of the output side. The back-end process or receives the image data sent from the front-end processor and then stores it temporarily in the image storage portion. Then, the back-end processor sends image data to the image recorder portion in sequence in accordance with the processing characteristics of the output side, and controls the image recorder portion for printing.

For example, this allows the front-end processor and the image recorder portion to perform asynchronous processing, and the back-end processor and the image recorder portion to perform synchronous processing, the difference therebetween being cancelled out by storing data in and reading the data out of the image storage portion.

Thus, upon performing the processing suitable for the output format based on the request by a client or the recovery processing, the image data is sent to the image recorder portion after each functional portion of the back-end processor and the output side such as the image recorder portion are controlled irrespective of the front-end process or to perform the processing in accordance with the output format desired by the client or recovery processing.

### BRIEF DESCRIPTION OF THE DRAWINGS

FIGS. 1A and 1B are views illustrating an embodiment of an image forming system according to the present invention;

FIG. 2 is a block diagram illustrating a first embodiment of a front-end processor FEP and a back-end processor BEP;

FIGS. 3A and 3B are explanatory views illustrating an implementation system example in relation to the system configuration according to the aforementioned embodiment;

FIGS. 4A to 4C are explanatory views illustrating the difference between a prior art image forming system and an image forming system to which the embodiment is applied; and

FIGS. 5A and 5B are schematic perspective views illustrating a prior art image forming system.

### DETAILED DESCRIPTION OF THE PREFERED EMBODIMENTS

Now, the present invention will be explained below with reference to the accompanying drawings in accordance with the embodiments.

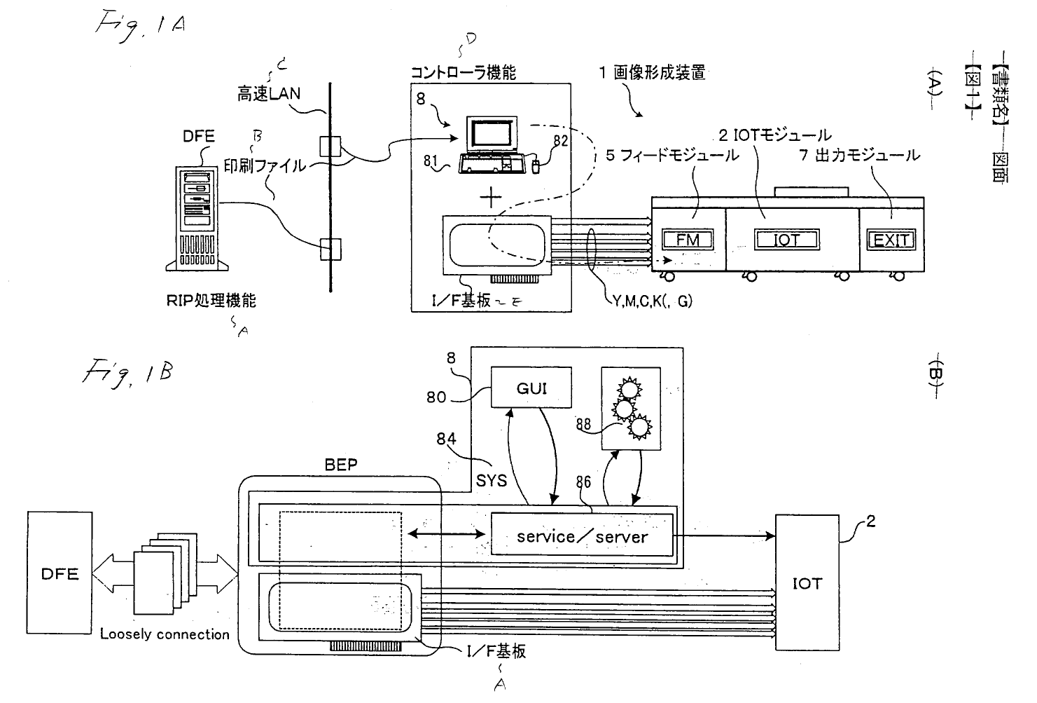

FIG. 1 is a view illustrating an image forming system according to an embodiment of the present invention. FIG. 1A is a schematic perspective view illustrating the configuration of the system, FIG. 1B showing an example of the system connected to a detailed user interface.

This image forming system comprises an image forming apparatus 1 and a DFE or a terminal apparatus that supplies print data to the image forming apparatus 1, thereby providing an instruction thereto to carry out printing.

As described in the prior art section, the image forming apparatus 1 is intended to utilize the electro-photography process to record images on a predetermined recording medium. The image forming apparatus 1 is adapted to function as a printer that forms visible images on the predetermined recording medium in accordance with the print data supplied from a client terminal device.

That is, the image forming apparatus 1 in the image forming system comprises the IOT module (IOT main body) 2, the feeder module (FM) 5 for feeding sheets of paper, the output module 7, and a user interface 8 such as a personal computer (PC). The feed module 5 may be constructed in multiple stages. There may also be provided coupling modules for coupling between the modules if necessary.

Furthermore, there may be provided a finisher module at the stage subsequent to the output module 7. For example, the finisher module can be equipped with a stapler for stacking sheets of paper and binding them at their corners or at two or more portions of their side, or with a punching mechanism to punch holes used for filing. Preferably, the finisher module can be used in an off-line condition when disconnected from the user interface 8.

The image forming apparatus 1 serves as an image recorder portion according to the present invention. The internal configuration of the image forming apparatus 1 is generally the same as that of the prior art described above, and thus will not be repeatedly explained.

The DFE comprises a front-end processor FEP. Like the DFE shown in the prior art, the front-end processor FEP allows a front engine to perform ROP (Raster Operation), thereby converting data received from a client into raster data (through RIP processing) and then compressing the converted raster image. The RIP processing and compression processing are performed at high speeds so as to respond to the high-speed processing performed by the IOT module 2. On the other hand, the front-end processor FEP of the DFE has no printer controller function for performing printing control depending on the image forming apparatus 1, and is different from the DFE according to the prior art in performing only RIP processing in principle.

The user interface 8 has input devices such as a keyboard 81 and a mouse 82, a GUI (Graphic User Interface) portion 80 for receiving entered instructions while presenting images to the user. In its main body (not shown), the user interface 8 also comprises a system control portion Sys 85 serving as a server and the connection interface between each of the modules of the image forming apparatus 1 and the DFE. Furthermore, the user interface 8 has a printer controller function for performing printing control depending on the image forming apparatus 1.

With this arrangement, the portion of the printer controller function for providing control of the processing depending on the image forming apparatus 1 of the user interface 8 and the portion related to the connection interface are called BEP (Back-End Processor). Consequently, the user interface 8 configured according to this embodiment is adapted to include the GUI portion 80 and the printer controller function portion for providing control in accordance with the engine characteristics such as the IOT core portion 20.

The DFE allows the front engine to perform RIP processing on the code data generated by the client to create raster data and compresses the resulting data. Electric signals are transmitted between the front-end processor FEP on the DFE side and the back-end processor BEP on the side of the image forming apparatus 1 relatively loosely with respect to the IOT core portion 20. That is, the user interface 8 is constructed with a communications interface (loose connection with a general-purpose network) independent of the printing engine 30 serving as the image recorder portion.

For example, as shown in FIG. 1A, the DFE and the back-end processor BEP may be connected to each other with a high-speed wired LAN (Local Area Network) in accordance with a general purpose communications protocol at 1 GBPS (Gigabit per Sec) of communications speed. For example, print files are transferred in the form of files from the front-end processor FEP to the back-end processor BEP according to FTP (File Transfer Protocol) In contrast to this, electric signals are transmitted between the back-end processor BEP and the IOT core portion 20 constituting the image recorder portion (or the main portion thereof) relatively closely with respect to the IOT core portion 20. That is, the user interface 8 is constructed with a communications interface dependent on the printing engine 30 serving as the image recorder portion. For example, the connection is established by means of a dedicated communications protocol.

The user interface 8 incorporates control software for controlling the image forming apparatus 1, and is connected to a DFE comprising an image process system IPS. For example, the user interface 8 receives, from the DFE, print data processed through RIP processing (Raster Image Process) and printing control information relating to the number of printed sheets of paper and the size of the paper, allowing the image forming apparatus 1 to perform printing processing requested.

Print data includes fundamental colors for color printing, or three colors of yellow (Y), cyan (C), and magenta (M), and black (K), four colors (YMCK) in total. In addition to these four colors, a fifth color component, for example, gray (G) may be included.

The back-end processor BEP providing the printer controller function receives printing control information (a printing command) in conjunction with image data from the DFE via an interface portion in the image forming apparatus 1, providing a control function for printing (or processing dependent on engine characteristics) depending on the image forming apparatus 1. Furthermore, for example, the back-end processor BEP enables efficient high-speed output by utilizing the RIP processed data stored in the DFE for the purposes of outputting multiple sheets in a collation mode and reprinting for an additional printout after completion of the initial printing.

For this reason, the back-end processor BEP is provided with a controller for generating command codes in accordance with the printing control information received from the DFE to control the processing timing of each portion of the image forming apparatus 1 according to the engine characteristics. Additionally, the back-end processor BEP completes spooling so as to meet the engine characteristics such as the IOT module 2, the feed module 5, and the output module 7, and then passes image data to the IOT module 2. The back-end processor BEP provides control processing depending on the engine characteristics.

Furthermore, the back-end processor BEP automatically recovers clogged sheets of paper depending on the engine characteristics. The system also allows the front-end processor FEP to determine directions from a client, causing the front-end processor FEP to perform processing if possible for only the front-end processor FEP independent of each portion of the image forming apparatus 1 such as the IOT core portion 20, the fuser 70, and the finisher portion. Likewise, the front-end processor FEP is commanded to pass therethrough to the back-end processor BEP side such processing that is dependent on each portion of the image forming apparatus 1 and that should be carried out by the BEP processor.

For example, the DFE sends print file data including raster-based images processed by RIP processing to the back-end processor BEP. The print file data includes compressed raster-based image file data, e.g., in the form of TIFF (Tagged Image File Format) as well as printing control information such as the number of printouts, two-sided or one-sided printing, color/monochrome printing, combined printing, execution of sorting, or a requirement for stapling.

For example, the front-end processor FEP performs processing such as rotation, page allocation in one sheet of paper (N-UP), repeating, matching of paper sizes, correcting for differences among devices by CMS (Color Management System), resolution conversion, contrast adjustment, and specifying compression ratios (low/medium/high), without their control commands being notified to the back-end processor BEP (non-notification).

On the other hand, the types of processing strongly related to the processing characteristics of the image forming apparatus 1 (those dependent on the IOT) are positioning processing such as collation and two-sided printing, related to the finisher (e.g., a stamp, punch, and stapler) or the sheet tray: calibration processing such as adjustment of paper exit face (top or bottom) and correction of gray balance and color shift; and screen designation. The control commands of those types of processing are passed through the front-end processor FEP and thus processed by the back-end processor BEP.

Paper sizes may be adjusted not only by means of the front-end processor FEP but also the back-end processor BEP.

As described above, with the configuration according to this embodiment, image data is transferred in files as compressed data such as TIFF data toward the user interface 8, for example, by FTP (File Transfer Protocol). That is, the front-end processor FEP transfers jobs toward the back-end processor BEP one-sidedly in the order in which each job is subjected to RIP processing independent of the engine characteristics, and then the back-end processor BEP performs page reallocation for printing.

According to the configuration of this embodiment, the DFE is freed from complicated processing based on the engine characteristics, thereby making it possible for an ordinary PC (personal computer) to be employed as the DFE with software installed in the PC and thus provide the functions of the front-end processor FEP.

Additionally, the back-end processor BEP responsible for complicated processing based on the engine characteristics is freed from the RIP processing, thereby making it possible to flexibly change data conversion methods or printing control in accordance with the performance of the IOT module 2.

This makes it possible to readily provide the printer controller to the engine or the desired target required on business even when the front-end processor FEP does not have particular information on the engine characteristics and know-how.

That is, the back-end processor BEP can receive, from the front-end processor FEP, image data for forming images and image forming conditions (such as the number of copies, one-sided/two-sided printing, colors, sorting execution), and then provide control to the image forming operation of the associated apparatus in accordance with the engine characteristics. Unlike the conventional DFE, the back-end processor BEP is not limited in use of the standard controllers. This makes the control of the image forming operation by the back-end processor BEP more flexible in terms of speeds and expandability than that provided by the DFE. Accordingly, it is easy to provide the image forming apparatus 1 with improved speeds and functions.

The front-end processor FEP of the DFE can perform RIP processing and compression processing and the back-end processor BEP can carry out page reallocation in accordance with the image forming apparatus 1, and thus the DFE and the image forming apparatus 1 can be loosely related to each other (Loose connection). That is, the DFE is limited only to RIP processing or compression processing that is not affected by the performance of the image forming apparatus 1. This reduces the processing burden of the DFE, thereby making it possible to use a DFE comprising a general-purpose controller capable of performing high-speed processing and thus reducing total system costs.

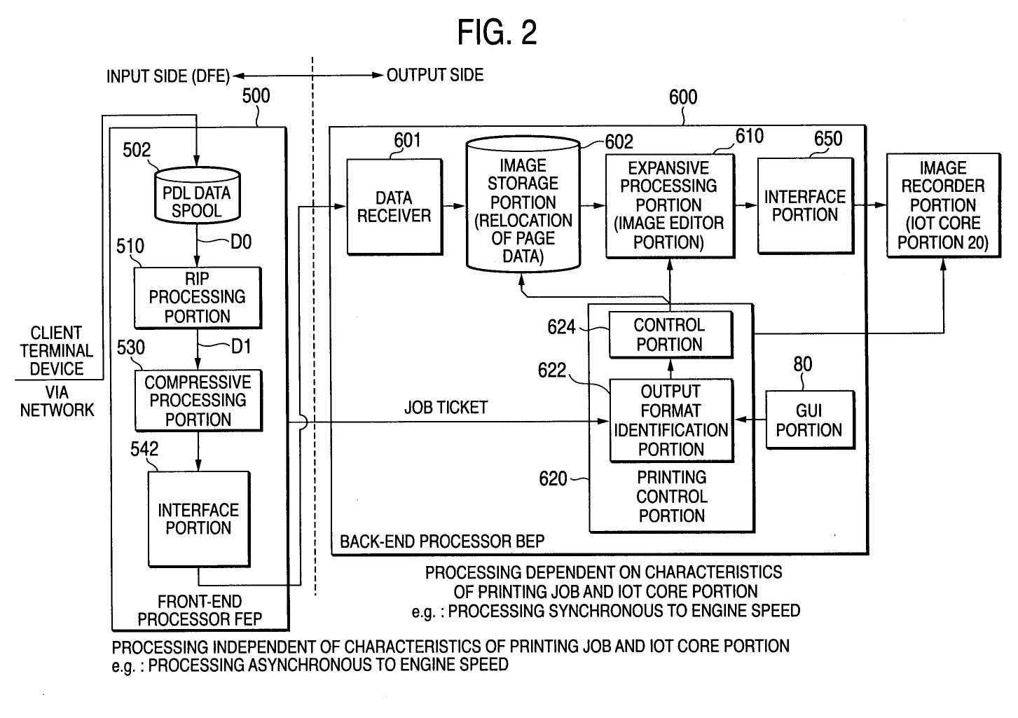

FIG. 2 is a view focused on the data flow between the DFE and the image forming apparatus 1, being a block diagram illustrating a first embodiment of a front-end processor FEP 500 and a back-end processor BEP 600.

The front-end processor FEP 500 comprises a data storage portion 502 for receiving print data described in PDL (hereinafter referred to as the PDL data) from a client terminal device (not shown) connected thereto via a network and then temporarily storing the PDL data, a RIP processing portion (raster image processing portion) 510 for reading and interpreting the PDL data from the data storage portion 502 to generate (rasterize) image data (raster data) in page units, and a compressive processing portion 530 for compressing the image data generated at the RIP processing portion 510 in a predetermined format.

At the stage subsequent to the compressive processing portion 530, there is provided a communications interface 542, independent of the image recorder portion, for transmitting electric signals between the output side such as the IOT module 2 or the output module 7 and the back-end processor BEP 600.

The RIP processing portion 510, an example of an image data generation portion, develops electronic data described in Page Description Language (PDL) to generate image data. For this purpose, the RIP processing portion 510 incorporates a decomposer serving as a PDL interpreter and an imager or the so-called RIP engine. As described later, the RIP processing portion 510 may be equipped with a dedicated RIP engine corresponding to the printing engine peculiar to this embodiment or with a general-purpose printing RIP engine. Alternatively, the entire front-end processor FEP 500 may be a RIP processing apparatus (DFE apparatus) provided by other manufacturers.

The compressive processing portion 530 compresses image data from the RIP processing portion 510 and then intermediately transfers the compressed image data to the back-end processor BEP 600. The front-end processor FEP 500 provides no change to a job ticket unnecessary for itself and indicative of the printing job contents received in conjunction therewith, intermediately transferring the job ticket to the back-end processor BEP 600 at predetermined timing.

The front-end processor FEP performs processing asynchronous to the speed of processing of the printing engine 30. That is, the front-end processor FEP 500 receives PDL data from a client terminal device, then performs raster and compression processing in sequence on the PDL data, and intermediately after that, sends the compressed image data to the back-end processor BEP 600. In the course of this process, when the reception of the PDL data from the client terminal device occurs earlier than the raster and compression processing, the front-end processor FEP 500 temporarily stores delayed PDL data in the data storage portion 502. Then, the PDL data is read out of the data storage portion 502 and processed in the order of reception (on a FIFO basis) or in an appropriate order (e.g., on a FILO basis).

On the other hand, the back-end processor BEP 600 comprises an image storage portion 602 for receiving and storing the compressed image data that is processed at the front-end processor FEP 500 independent of the printing job and the processing characteristics of the printing engine 30 (e.g., asynchronous to the processing speed of the printing engine 30), and an expansive processing portion 610 for reading the compressed image data from the image storage portion 602, performing expansive processing on the data corresponding to the compressive processing of the compressive processing portion 530 at the side of the front-end processor FEP 500, and sending the expanded image data towards the IOT core portion 20.

The expansive processing portion 610 has an image editor function according to the invention for performing rotation of an image or adjustment of the position of the image on a sheet of paper or enlargement or contraction on the expanded image data read from the image storage portion 602. This functional portion responsible for this image editor function may be provided independent of the expansive processing portion 610.

At the stage previous to the image storage portion 602, there is provided a data receiver portion 601 equipped with a communication interface portion independent of the image recorder portion for transmitting electric signals between the front-end processor 500 and the output side, such as the IOT module 2 or the output module 7.

Also, at the stage subsequent to the expansive processing portion 610, there is also provided a communication interface portion 650 on the output side for transmitting electric signals between the image recorder portion and the communication interface dependent of the image recorder portion.

Furthermore, the back-end processor BEP 600 comprises a printing control portion 620 serving as a printer controller for providing control to each portion of the back-end processor BEP 600 or the IOT core portion 20 dependent on the processing performance of the IOT core portion 20.

The printing control portion 620 comprises an output format identification portion 622 for interpreting (decoding) the job ticket supplied from the front-end processor FEP 500 or receiving user instructions via the GUI portion 80 to identify the output format (the position of an image in a page or the exit order and orientation of the pages) in accordance with the processing characteristics of the printing engine 30, the fuser 70 or the finisher, and a control portion 624 for controlling each portion of the printing engine 30, the fuser 70 or the finisher so that the printout is outputted in an output format identified by the output format identification portion 622. The output format identification portion 622 is provided with a function as an output format information acquisition portion for receiving information related to an output format desired by a client.

The back-end processor BEP 600 accumulates temporarily the image data transferred from the front-end processor FEP 500 in the image storage portion 602 that serves as a buffer. The expansive processing portion 610 reads and expands the compressed image data from the image storage portion 602, assembles the page data (reallocation of page data) in accordance with the printing job specified by a client terminal device or the front-end processor FEP 500, and prepares for transferring the page data to the designated printing engine.

Then, the back-end processor BEP 600 sends the page data at a speed maximizing the productivity of the engine while exchanging control commands synchronous to the processing speed of the printing engine 30.

When the front-end processor FEP 500 sends data earlier than the processing (synchronous processing) suitable for the processing characteristics of the printing engine 30 is performed, the back-end processor BEP 600 temporarily stores delayed image data or a job ticket in the image storage portion 602. The back-end processor BEP 600 then reads page data so as to match the exit conditions (orientation of the pages or execution of finishing processing) desired by the user, edits images as required, corrects the position of the image on a sheet of paper, performs image forming processing as desired by the user, and sends the processed image data to the IOT module 2.

This provides asynchronous processing between the front-end processor FEP 500 and the output side such as the printing engine 30 or the fuser 70 serving as the image recorder portion, and synchronous processing between the back-end processor BEP 600 and the output side, the difference therebetween being cancelled out by storing the data in and reading the data out of the image storage portion 602. Even in the case of compressing or expanding the image data, the compressive processing at the front-end processor FEP 500 and the expansive processing at the back-end processor BEP 600 are carried out synchronous to each other. That is, according to the configuration of the first embodiment, the RIP processing at the front-end processor FEP 500 or the subsequent compressive processing are performed independent of the printing job contents, the processing characteristics of the IOT core portion 20 and the fuser 70 which constitute the image recorder portion.

As described above, in the front-end processor FEP 500 according to the first embodiment, the image data rasterized (graphically developed) from the Page Description Language at the RIP processing portion 510 is transferred in the order of the pages to the back-end processor BEP 600 loosely related thereto. Up to this stage, the processing is performed according to the performance of the RIP engine, requiring no special need to depend on the processing speed (synchronous) or control of the printing engine.

To realize these types of processing, the printing control portion 620 serving as the printer controller 620 interprets (decodes) the job ticket supplied by the front-end processor FEP 500 or receives user instructions via the GUI portion 80 to control each portion.

For example, the expansive processing portion 610 reads the compressed image data from the image storage portion 602 and performs expansive processing synchronous to the processing speed of the printing engine 30. As required, the front-end processor FEP also performs processing data (conversion of color data) dependent on the printing engine 30 and then sends the resulting data to the printing engine 30. At this time, in accordance with the printing job, the printing control portion 620 sorts pages in the ascending or descending order, determines the order of pages to be printed at the time of two-sided printing, or performs page reallocation such as repositioning corresponding to the finisher (securing the positions of holes for stapling or punching). This allows printouts to be outputted in the form specified by the client irrespective of the type of the IOT core portion 20 or the finisher portion.

As described above, in the configuration according to the first embodiment, the front-end processor FEP 500 transfers image data in files as TIFF compressed data, for example, by FTP to the back-end processor BEP 600. That is, both are loosely related to each other only for file transfer, and thus the front-end processor FEP 500 transfers each job to the back-end processor BEP 600 one-sidely, in the order in which the jobs are processed through the RIP processing, independent of the engine characteristics. The back-end processor BEP 600 is responsible for those types of processing such as reallocation of pages for printing dependent on printing job or the printing engine 30.

According to the embodiment, the front-end processor FEP 500 is freed from complicated processing based on the engine characteristics, thereby making it possible for an ordinary PC (personal computer) to be employed with software installed therein as the front-end processor FEP 500 and thus provide the functions of the front-end processor FEP 500. That is, a general-purpose front-end processor FEP 500 can be realized.

Additionally, the back-end processor BEP 600 responsible for complicated processing based on the engine characteristics is freed from the RIP processing, thereby making it possible to flexibly change processing or control in accordance with the performance of the IOT module 2, the fuser 70 or the finisher.

This makes it possible to readily provide the printer controller equipped with a general-purpose RIP engine for the engine or the desired target required on business even when the front-end processor FEP 500 does not have particular information on the engine characteristics or know-how.

Since the front-end processor FEP 500 is independent of the printing engine 30, the user can also use his newly purchased printing engine for his conventional front-end processor. Furthermore, the user can also connect the printing engine to a front-end processor supplied by other manufacturers. That is, it is possible to use a general-purpose RIP engine or a RIP engine by other makers.

For example, in the Unexamined Japanese Patent Application Publication No. Hei 10-166688, a system in which a front-end processor FEP is separated from the back-end processor BEP for controlling the image recorder portion is suggested. However, in this system, the RIP processing is dependent on the printing job and the printing engine performance. For this reason, upon controlling the image data to be outputted to the IOT core portion 20 in a predetermined order, the back-end processor BEP issues a request for acquiring a next job to the front-end processor FEP at the time the printing processing of a printing job is completed. This request for acquiring a next job is informed to the front-end processor FEP via a network.

The front-end processor FEP performs the RIP processing on the new job in response to the acquisition request and then supplies the processed data to the back-end processor BEP. That is, although the RIP processing portion and the printer controller portion are separated from each other in terms of hardware, there is no substantial difference from the conventional one in that the RIP processing is dependent on the printing job and the performance of the printing engine 30. This is common to the implementation according to the first embodiment in that the RIP processing portion and the printer controller portion are separated from each other in terms of hardware, but totally different in dependency of the RIP processing on the printing job and the performance of the engine.

For example, in a case where re-processing related to the RIP processing is required, such as page allocation in one sheet of paper (N-UP), repeating, matching of paper sizes, correcting for differences among devices by CMS (Color Management System), resolution conversion, contrast adjustment, and specifying compression ratios (low/medium/high), the system disclosed in the Unexamined Japanese Patent Application Publication No. Hei 10-166688 regenerates image data at the front-end processor FEP and then transfers the resulting data to the back-end processor. Thus, a front-end processor FEP equipped with a general-purpose RIP engine suffers from a significant burden of processing and requires a significantly long time for processing. Additionally, data needs to be retransmitted, thereby resulting in an increase in communications load.

On the other hand, in a case where required are the types of processing, dependent on the processing characteristics of the image forming apparatus 1 (e.g., the printing engine) on the output side, such as rotation of images, collation, two-sided printing, and image shift which are related to the finisher (e.g., a stamp, punch, and stapler) or the sheet tray: calibration processing such as adjustment of paper exit face (top or bottom) and correction of gray balance and color shift; and screen designation, the system disclosed in the Unexamined Japanese Patent Application Publication No. Hei 10-166688 requires the front-end processor FEP to regenerate image data to transfer the resulting data to the back-end processor based on thorough knowledge of the engine characteristics or know-how or. Thus, a front-end processor FEP equipped with a general-purpose RIP engine suffers from a heavier burden of processing than that of reattempt of RIP processing and requires a significantly long time for processing.

In contrast to this, the configuration according to the embodiment is divided into the front-end processor FEP 500 and the back-end processor BEP 600. In accordance with the processing characteristics of the image recorder portion on the output side such as the printing engine 30 and the fuser 70, the printing control portion 620 for controlling the printing engine 30 on the output side is removed from the FEP 500, so that the FEP 500 can devote itself to the RIP processing or compressive processing. The printing control portion 620 removed from the front-end processor FEP 500 is relocated onto the back-end processor BEP 600 that is tightly connected to the output side. Additionally, the data received from the front-end processor FEP 500 is held in the image storage portion 602.

This arrangement makes it possible to provide a system that allows the front-end processor FEP 500 to be loosely related to the output side, there by making the processing of the front-end processor FEP 500 independent of the printing engine 30 or the output side. The difference in the course of processing is cancelled out (adjusted) by storing the data in and reading the data out of the image storage portion 602.

For example, the processing related to the RIP processing is carried out by means of the front-end processor FEP; however, when the RIP processing needs to be re-performed, reuse of the data stored in the image storage portion 602 is made without requiring the front-end processor FEP 500 to re-perform the RIP processing (independent of the front-end processor FEP 500). This eliminates the need of re-performing the RIP processing at the front-end processor FEP 500, thereby reducing the burden of the front-end processor FEP 500 by that amount. Since data does not need to be re-transmitted, transmission load is reduced and the total processing is performed faster.

Furthermore, processing dependent on processing characteristics of the output side can be performed at the back-end processor BEP 600 that has a performance adapted to the output side such as a printing engine and is closely related to the printing engine 30 or the like. For example, in a case where such processing is required that is dependent on the processing characteristics of the output side when the output is provided in the form desired by the client, irrespective of the front-end processor FEP 500 (i.e., independently), the system controls each functional portion of the back-end processor BEP 600 to perform processing according to the output format desired by the client and send image data to the output side. It is not a heavy burden to perform the processing adapted to the engine at the back-end processor BEP 600. For this reason, the configuration according to this embodiment provides improved throughput.

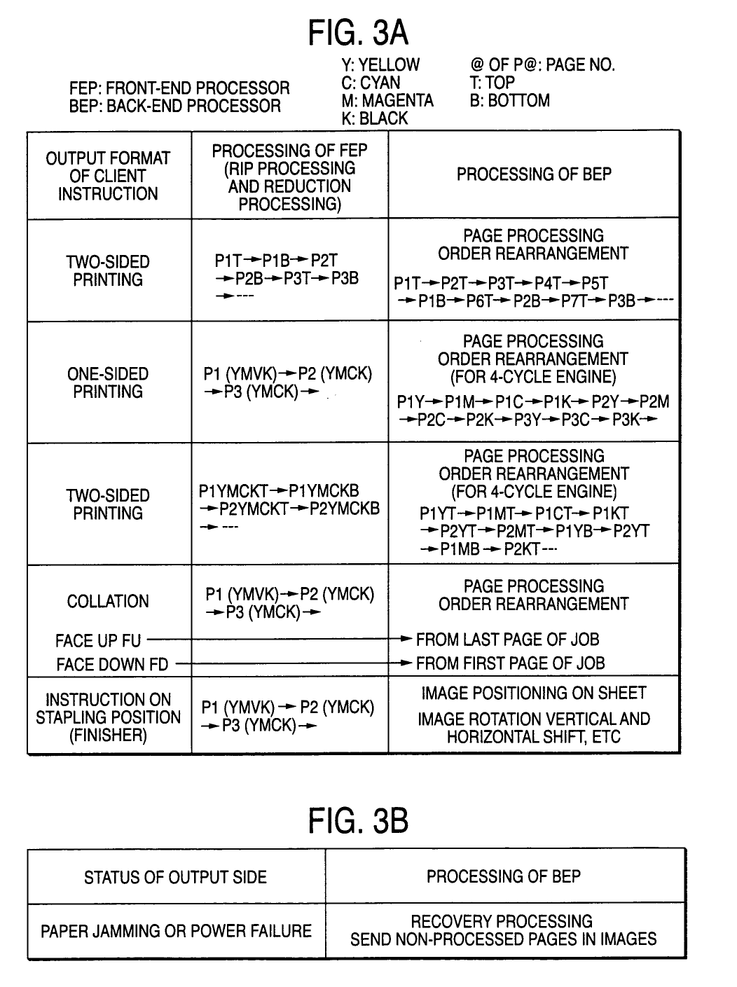

FIG. 3 is an explanatory view illustrating an implementation system example in relation to the system configuration according to the aforementioned embodiment. FIG. 3A is an explanatory view illustrating the processing of the back-end processor in relation to the output format in accordance with the instruction of a client. FIG. 3B is an explanatory view illustrating the processing of the back-end processor performed in the case of an abnormal situation occurring on the output side.

As shown with the first item in FIG. 3A, in a case where an output format identification portion 622 having the function of the output format information acquisition portion receives information indicative of a two-sided output instruction as the information related to the output format desired by the client, the control portion 624 provides control to the expansive processing portion 610 in the back-end processor BEP 600 so as to successively generate a one-sided image in a sequence dependent on the processing characteristics of the output side such as the printing engine 30 and the fuser 70 and then output the resulting data to the printing engine 30. This allows two-sided images to be generated in the sequence dependent on the processing characteristics of the output side.

For example, based on the two-sided exit instruction (an instruction by the client) provided via the front-end processor FEP 500, the back-end processor BEP 600 outputs the image to the printing engine 30 in the order of sequence in which the image is carried by the belt on the side of the printing engine 30. More specifically, the front-end processor FEP 500 performs in sequence in a manner such as the top of the first sheet (P1T), the bottom of the first sheet (P1B), the top of the second sheet (P2T), the bottom of the second sheet (P2B), the top of the third sheet (P3T), the bottom of the third sheet (P3B), and so on. The front-end processor FEP 500 then sends the generated image data sequentially to the back-end processor BEP 600.

In contrast to this, the back-end processor BEP 600 may take a sequence such as the top of the first sheet (P1T), the top of the second sheet (P2T), the top of the third sheet (P3T), the top of the fourth sheet (P4T), the top of the fifth sheet (P5T), the bottom of the first sheet (P1B), the top of the sixth sheet (P6T), the bottom of the second sheet (P2B), the top of the seventh sheet (P7T), the bottom of the third sheet (P3B), and so on. These arrangement orders differ depending on the processing characteristics related to the printing speed of the apparatus.

Furthermore, as shown with the second item in FIG. 3A, the front-end processor FEP 500 performs the RIP processing in parallel for each color component of yellow (Y), magenta (M), cyan (C), and black (K), and then sends the image data of each page of YMCK to the back-end processor BEP 600. In a case where the printing engine 30 is a four-cycle engine that performs processing in the order of Y, M, C, and K, the back-end processor BEP 600 carries out sorting of the pages to be processed in such a manner as the first sheet yellow (Y), the first sheet magenta (M), the first sheet cyan (C), the first sheet black (K), the second sheet Y, the second sheet M, the second sheet C, the second sheet K, and so on.

As shown with the third item in FIG. 3A, for combining this arrangement and the two-sided printing, the front-end processor FEP 500 sends image data to the back-end processor BEP 600 in such a manner for each page as the first sheet top (P1YMCKT), the first sheet bottom (P1YMCKB), the second sheet top (P2YMCKT), the second sheet bottom (P2YMCKB), and so on.

Corresponding to this, for example, the back-end processor BEP 600 carries out sorting in such an order as the first sheet Y top (P1YT), the first sheet M top (P1MT), the first sheet C top (P1CT), the first sheet K top (P1KT), the second sheet Y top (P2YT), the second sheet M top (P2MT), the first sheet Y bottom (P1YB), the second sheet C top (P2CT), the first sheet M bottom (P1MB), the second sheet K top (P2KT), and so on.

According to the system of this embodiment, even when it is necessary to carry out sorting processing on the pages to be processed in accordance with the processing characteristics of the output side due to the apparatus configuration described above, it is possible to perform processing corresponding thereto only on the side of the back-end processor BEP 600 without affecting the front-end processor FEP 500.

As described above, the system according to this embodiment makes it possible to provide control in the formation of images in a sequence suitable for the apparatus on the side of the back-end processor BEP 600 in accordance with the processing characteristics of the output side (including the configuration of the printing engine) without affecting the front-end processor FEP 500 (without imposing any burden on the front-end processor FEP 500).

In the presence of a two-sided printing instruction during continuous two-sided printing, the system interrupts the continuous front-face transport to insert the bottom face printing processing of a sheet. Accordingly, it becomes more difficult to provide control in sorting of pages to be processed (page processing order sort control) such as when to start the image forming process for the next sheet. For this reason, the front-end processor FEP performing the RIP processing and providing this control in parallel would be burdened with a heavy load and incapable of following operations at higher speed.

In contrast to this, the configuration according to this embodiment is adapted to exclude the page processing order sort control corresponding to the both sides from the RIP processing of the front-end processor FEP 500 and allow only the back-end processor BEP 600 to carry out the page processing order sort control, thereby providing control to each portion of the back-end processor BEP 600 and the printing engine 30. This makes it possible to operate more flexibly at higher speeds when compared with the conventional configuration.

As shown with the fourth item in FIG. 3A, in a case where the output format identification portion 622 having the function of the output format information acquisition portion receives information indicative of the instruction related to collation as the information related to the output format desired by the client, the control portion 624 controls the expansive processing portion 610 in the back-end process or BEP 600 to perform collation processing in accordance with the exit paper face dependent on the processing characteristics of the output side (the image recorder portion). This makes it possible to exit printouts in the orientation desired by the client without depending on the exit processing characteristics of the output side.

For example, in a case where it is possible to select and instruct either one of the face up FU or face down FD as the exit paper face instruction, for arranging in the order of pages in the face down FD, pages can be outputted in a normal manner from the first page according to the job. However, for arranging in the order of pages in the face up FU, pages must be outputted from the last page according to the job, i.e., the pages to be processed need to be rearranged.

The back-end processor BEP 600 according to this embodiment is configured to be capable of reading and processing desired pages from the image storage portion 602. Accordingly, the back-end processor BEP 600 can read pages from the image storage portion 602 to rearrange and expand them for outputting them to the printing engine 30 without affecting the front-end processor FEP 500 (without imposing any burden on the front-end processor FEP 500).

As shown with the fifth item in FIG. 3A, in a case where the output format identification portion 622 having the function of the output format information acquisition portion receives information indicative of a stapling-related instruction as information related to the output format desired by the client, the control portion 624 controls the expansive processing portion 610 in the back-end processor BEP 600 to perform stapling positioning processing dependent on the processing characteristics of the output side (the image recorder portion).

Even with (optional) devices such as a stamp, stapler, or punch, this procedure makes it possible for the back-end processor BEP 600 to perform the image editing processing such as image rotation and position shift in accordance with the positions stamped, stapled, or punched, and then send position-adjusted image data to the printing engine 30, without affecting the front-end processor FEP 500 (without imposing any burden on the front-end processor FEP 500).

For example, for the two-sided printing, the direction of rotation or positional shift is different depending on the page number. Thus, the conventional configuration in which the directions are determined and the actual image editing processing and the RIP processing are performed in parallel will be imposed with the load of the determination and the image editing processing, thereby making it difficult to operate at higher speeds. In contrast to this, the configuration according to this embodiment allows the front-end processor FEP 500 to exclusively perform the RIP processing or the compressive processing independent of the processing on the output side. Furthermore, the back-end processor BEP 600 can exclusively perform the determination on the directions or the image editing processing without being bothered by the RIP processing and the compressive processing, thereby facilitating the operation at higher speeds with the processing burdens distributed.

When the position of an image on a sheet is adjusted, the amount of adjustment may cause part of the original image to extend off the sheet or a non-printed portion to occur (a so-called image chipping) even when the image does not extend off the sheet. In these cases, the image size may be slightly reduced (size matching processing), and the reduced image data may be sent to the printing engine 30. The reduction in size may be carried out in the necessary transverse or lateral direction caused by the positional shift (independent reduction).

On the other hand, the size matching processing may be performed only when desired by the client after the client instructs whether the size matching processing should be processed. Alternatively, on the contrary, it can be set that the size matching processing is performed in the normal mode and not performed only when the client cancels this mode.

Furthermore, as shown in FIG. 3B, in a case where the output jamming is occurred in the course of the printing job processing, the control portion 624 controls each functional portion of the back-end processor so as to perform recovery processing of the output jamming dependent on the processing characteristics of the output side (the image recorder portion).

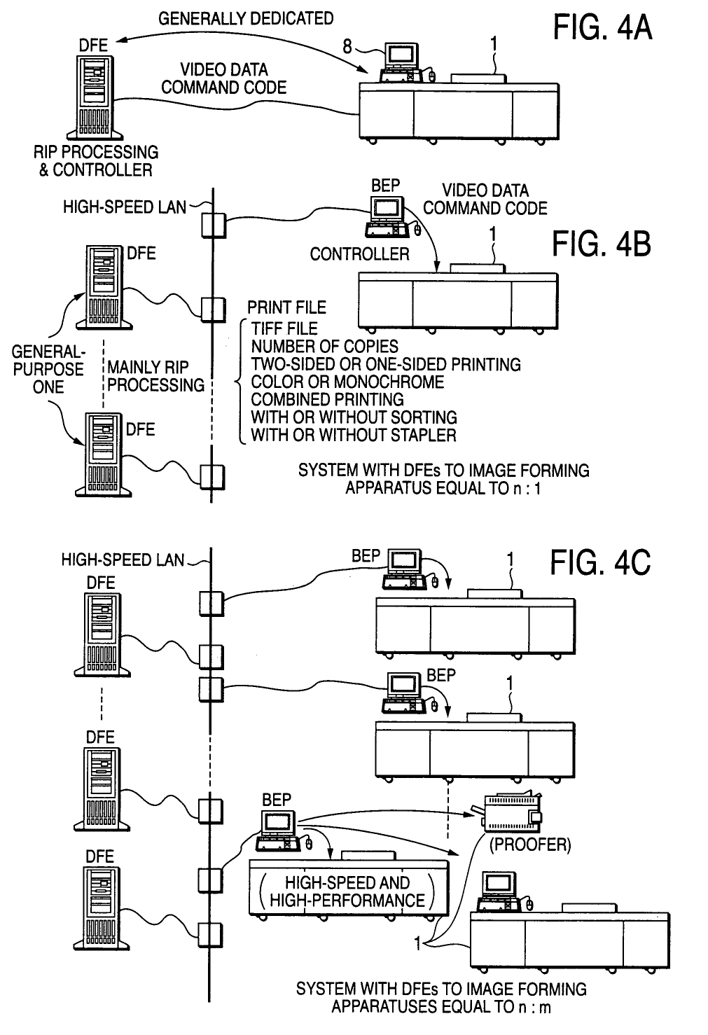

For example, in a case where an image is not allowed to exit due to an output jamming (paper jamming) or power failure on the IOT module 2 or the output module 7, the back-end processor BEP 600 reads a non-outputted desired page (anon-processed page) from the image storage portion 602 and then sends the page to the printing engine 30. This makes it possible to implement the recovery processing only on the side of the back-end processor BEP 600 without affecting the front-end processor FEP 500 (without imposing any burden on the front-end process or FEP 500) FIG. 4 is an explanatory view illustrating the difference between the prior art image forming system and the image forming system incorporating the embodiment. FIG. 4A shows the prior art configuration, while FIGS. 4B and 4C show an exemplary system configuration according to the first embodiment.

In the example of the prior art configuration, the image data (or video data) processed through the RIP processing in accordance with the characteristics of the image forming apparatus 1 is passed from the DFE to the IOT module 2. Upon improving the speed of the image forming apparatus 1, the higher the speeds, the more difficult for the controller on the DFE to control the processing timing of each portion in the image forming apparatus 1. For this reason, as shown in FIG. 3A, the DFE and the image forming apparatus 1 are substantially inseparable, thereby resulting in such a configuration in which a dedicated DFE is used to respond to individual image forming apparatus 1.

For example, upon developing raster data (i.e., the RIP processing) or controlling a printing unit, a high-performance model of DFE employs an industry standard controller that claims high image quality and high-level control. Unless the front-end processor FEP has thorough knowledge of the engine characteristics and know-how, it is impossible to control the high-speed and highly functional image forming apparatus 1. However, the higher the speed and function, the more difficult the control becomes. Accordingly, the prior art configuration needs a DFE that performs the dedicated processing function suitable for the image forming apparatus 1. For this reason, it was difficult to construct a system in which one image forming apparatus 1 receives printing requests from a plurality of DFEs.

For example, in a case where the system is improved in function and speeds, what can be done is only to inform a standard controller in advance of a method for controlling the image forming apparatus 1, allowing the image forming apparatus 1 to operate under the control of the standard controller. However, improved speeds and function make it difficult to control the image forming operation of the image forming apparatus 1 at the improved speeds and function by means of the prior art controller or a general-purpose controller.

In contrast to this, the configuration according to the first embodiment is implemented such that the DFE (more specifically, the front-end processor FEP 500) is mainly responsible for the RIP processing functional portion and the back-end processor BEP 600 is responsible for the printer controller function. This makes it possible for the back-end processor BEP 600 to receive image data for forming images and image forming conditions (such as the number of copies, one-sided/two-sided printing, colors, execution of sorting), and control the image forming operation of the associated apparatus in accordance with the performance and characteristics of the printing engine.

Unlike the conventional DFE, the back-end processor BEP 600 is not limited in use of the standard controllers. This makes the control of the image forming operation by the back-end processor BEP 600 more flexible in terms of speeds and expandability than that provided by the DFE. Accordingly, it is easier to provide the image forming apparatus 1 with improved speeds and functions when compared with the conventional structural examples.

Furthermore, in the configuration according to the first embodiment, the front-end processor FEP 500 can perform the RIP processing while the back-end processor BEP 600 can carry out page reallocation to the image forming apparatus 1, and thus the DFE (more specifically, the front-end processor FEP) and the image forming apparatus 1 (more specifically, the printing engine or the fuser) can be loosely related to each other (Loose connection). That is, the front-end processor FEP and the printing engine or the like can be loosely related to each other, thereby making it possible to limit the processing of the DFE within the range, such as the RIP processing, which is not affected by the processing characteristics of the image forming apparatus 1.

This reduces the processing burden of the DFE, thereby making it possible to use a DFE comprising a general-purpose controller capable of performing high-speed processing and thus reducing total system costs. In addition to this, as shown in FIG. 3B, since a general-purpose DFE can be used, it is possible to construct a system in which one image forming apparatus 1 receives printing requests from a plurality of DFEs, i.e., a system having a ratio of the number of DFEs to that of image forming apparatuses equal to n:1.

Furthermore, as shown in FIG. 4C, it is also possible to construct a system having a plurality of image forming apparatuses 1 connected thereto, i.e., a system having a ratio of the number of DFEs to that of image forming apparatuses equal to n:m. In this case, it is possible to provide a system in which two types of image forming apparatuses 1, such as a high-speed and high-performance image forming apparatus 1 and an output check proofer (an example of the image forming apparatus 1), are disposed in parallel or alternatively in cascade for parallel processing at the stage subsequent to the back-end processor BEP.

A system with a proofer connected thereto can be used to construct a DDCP (Digital Direct Color Proofing) system in which the proofer outputs color calibration prints directly from DTP data before the high-speed and highly-functional image forming apparatus 1 performs direct printing. For example, after having received proof data as a printing job, the back-end processor BEP outputs image data to the proofer in a form suitable for proofing (e.g., in the form of low video rate) and then instructs the proofer to output the color calibration print. Meanwhile, when having received an ordinary printing job, the back-end processor BEP outputs image data having high video rates to a high-speed and highly-functional machine, issuing an instruction for high-speed and highly-functional printing.

In the case of the system shown in FIG. 4C, it is preferable to incorporate a CMS (Color Management System) for correcting for a subtle difference in output color between the high-speed and high-performance machine and a proofer or a type of apparatus connected in cascade.

As described above, the system of n:1 or n:m (a multi-system) makes it possible to provide efficient output processing according to the availability of the image forming apparatus 1 or by selecting an image forming apparatus suitable for the printing job.

Even in the multi-system as described above, the system is common to that of the configuration shown in FIG. 2 in that the front-end processor FEB is loosely related to and can perform processing independent of the processing characteristics of the output side, and the back-end processor BEP tightly connected to the output side performs the processing dependent on the processing characteristics of the output side.

Thus, even in the multi-system as described above, to meet the exit form in accordance with an instruction of the client or the recovery processing, only the back-end processor BEP is sufficient without affecting the front-end processor. That is, in the entire multi-system, the front-end processor FEP (DFE) can exclusively perform the RIP processing, the compressive processing or the recovery processing independent of the processing on the output side. Furthermore, the back-end processor BEP can exclusively perform the determination in the orientation or the image editing processing or the recovery processing without being bothered by the RIP processing and the compressive processing, thereby facilitating the operation at higher speeds.

The present invention is described with reference to the embodiments; however, the technical scope of the present invention is not limited to those of the aforementioned embodiments. A variety of changes and modifications can be made to the aforementioned embodiments without departing from the scope and spirit of the present invention, and those changes and modifications are also included in the technical scope of the present invention.

The aforementioned embodiments are not intended to limit the present invention according to the claims, and all the combinations of the features described in the embodiments are not necessarily the means for solving the problems according to the present invention. The aforementioned embodiments include various steps of the invention, and it is possible to extract various types of inventions in appropriate combinations of a plurality of constituent features disclosed. Even when several constituent features are excluded from all the constituent features indicated in the embodiments, the remaining constituent features can also be extracted so long as they provide inventive effects.

For example, in the aforementioned embodiments, the relation between an instruction of a client and the exit form such as the exit sheet face (FU/FD) or the finisher, and the recovery processing for paper jamming, however, the present invention is not limited thereto. For example, in the relation between the exit form based on the client instruction and the orientation and size of an image read out of the image storage portion 602 or the orientation and size of a sheet of paper, the image may be edited so that the image is printed on the sheet in a predetermined orientation and size.

For example, in a case where an image is oriented laterally and the sheet is oriented transversely, and the client provides an instruction of “automatic matching, ” the expansive processing portion 610 having the image editor function rotates the image by 90 degrees (alternatively by 270 degrees), and may zoom (enlarge or contract) it if the size is not acceptable. On the other hand, in a case where the client provides an instruction of a “fixed size” or instructed to output the image without changing the orientation and size of the original image, the image may be delivered without being particularly edited. On the other hand, in a case where the client instructs to use the automatic matching for only either the size or the orientation, the image may be rotated or zoomed to meet the instruction.

Furthermore, in the aforementioned embodiments, the two-sided printing and finisher are explained as an example of output format in accordance with a client instruction; however, the invention is not limited thereto and a binding margin may be instructed, for example. In this case, in order to ensure the binding margin on a sheet, it is necessary to shift the position of the image. In this case, in the same way to meet the finisher, the back-end processor BEP can shift the position. Additionally, the matching processing may be performed on the image size as required.

In the aforementioned embodiments, such a case is described in which the present invention is applied to a system that employs the electro-photography process as the printing engine or the main portion for forming visible images on a recording medium. However, the applicable scope of the present invention is not limited thereto. For example, the present invention is also applicable to an image forming system comprising an image forming apparatus for forming visible images on sheets of plain paper or photosensitive paper with an engine equipped with a conventional image forming mechanism such as a heat-sensitive, thermal transfer, ink-jet mechanism, or the like.

Furthermore, in the aforementioned embodiments, such an exemplary printer is explained which comprises an image forming apparatus having a printing engine employing the electro-photography process. However, the image forming apparatus is not limited thereto, and may be any one such as a color copier or a facsimile so long as it has a so-called printing capability for forming images on the recording medium.

Furthermore, in the aforementioned embodiments, the front-end processor FEP 500 performs the compressive processing on data and then sends the data to the back-end processor BEP 600. The back-end processor BEP 600 then performs the expansive processing on the data and then sends the image data to the printing engine 30. However, these types of compressive and/or expansive processings are not essential.

For example, as the compressive and/or expansive processings described in the Unexamined Japanese Patent Application Publication No. Hei 8-6238, it is possible to perform processing suitable to the characteristics of an image object, e.g., an image object (a line work character object LW) represented mainly by line work or characters and an image object (multi-tone or continuous tone image object CT) represented mainly by multi tones such as background portions or a photographic portion.

As described above, according to the present invention, first, the front-end processor is configured to generate image data independent of the processing characteristics of an image recorder portion. The back-end processor is provided with an image storage portion for receiving and storing image data processed by the front-end processor independent of the processing characteristics of the image recorder portion. The back-end processor is also provided with a printing control portion for providing control to perform processing, dependent on the image storage portion, on image data read from the image storage portion and then send the resulting data to the image storage portion.

Even when processing is performed in accordance with the output format desired by the client or recovery processing is performed, these types of processings can be performed without affecting the front-end processor. This facilitates the development of a high-performance and highly functional system even when the exit processing or recovery processing is performed in accordance with an instruction from the client.

That is, in the conventional system configuration, one front-end processor was responsible for a RIP engine for generating image data (performing RIP processing) and a printer controller for controlling the image recorder portion in accordance with the processing characteristics of the image storage portion (mainly the printing engine).

In contrast to this, the configuration according to the present invention is designed such that the system is divided into a front-end processor and a back-end processor, while the printer controller for controlling the image recorder portion in accordance with the processing characteristics of the image storage portion is removed from the front-end processor, whereby the front-end processor is allowed to exclusively perform the RIP processing in principle. On the other hand, the printer controller removed from the front-end processor is relocated at the back-end processor that is tightly connected to the image recorder portion.

This allows the front-end processor and the image recorder portion to be loosely related to each other, thereby making it possible to construct a system in which the processing on the front-end side is not dependent (independent of) on the printing engine. That is, the front-end processor can exclusively generate images or the like without considering the output side, while the back-end processor can exclusively perform the image forming operation of the printing engine or the like without considering the image generation.

Accordingly, this allows the front-end processor to perform efficient RIP processing using a general-purpose RIP engine. The back-end processor is responsible for the control of processing suitable for the devices on the output side. For example, only the back-end processor controls the functional portions of the back-end processor and the image recorder portion without affecting the front-end processor, so as to perform processing in accordance with the output format desired by the client. Furthermore, the back-end processor will perform recovery processing for the output jamming without affecting the front-end processor. Accordingly, this facilitates the development of a high-performance and highly functional system even when the exit processing or the recovery processing is performed in accordance with an instruction from the client.

[FIG. 1A]

1: Image forming apparatus

2: IOT module

5: Feed module

7: Output module

A: RIP processing function

B: Print file

C: High-speed LAN

D: Controller function

E: I/F board

[FIG. 1B]

A: I/F board

[FIG. 2]

80: GUI portion

500: Front-end processor FEP

502: Data storage portion

510: RIP processing portion

530: Compressive processing portion

600: Back-end processor BEP

602: Image storage portion (Relocation of page data)

610: Expansive processing portion (Image editor portion)

620: Printing control portion

622: Output format identification portion

624: Control portion

A: Client terminal device

B: Via network

C: Input side (DEF)

D: PDL data spool

E: Processing independent of the characteristics of printing job and IOT core portion

(e.g.) processing asynchronous to engine speed

F: Output side

G: Job ticket

H: Image recorder portion (IOT core portion 20)

I: Processing dependent on the characteristics of printing job and IOT core portion

(ex.) processing synchronous to engine speed

[FIG. 3A]

| | | |
|---|---|---|
| FEP: Front-end processor | Y: Yellow | @ of P@: page No. |
| BEP: Back-end processor | C: Cyan | T: Top |
| | M: Magenta | B: Bottom |
| | B: Black | |

| Output format | Processing of FEP | |
|---|---|---|
| of client | (RIP processing and | |
| instruction | reduction processing) | Processing of BEP |
| Two-sided | P1T→P1B→P2T→P2B→ | Page processing order |
| printing | P3T→P3B→ | rearrangement |
| | | P1T→P2T→P3T→P4T |
| | | →P5T P1B→P6T→P2B |
| | | →P7T→P3B→ |
| One-sided | P1 (YMVK)→P2 (YMCK) | Page processing order |
| printing | →3P (TMCK)→ | rearrangement (for |
| | | 4-cycle engine) |
| | | P1Y-43 P1M-43 P1C→ |
| | | P1K→P2Y→P2M→P2C |
| | | →P2K→P3Y→P3C→ |
| | | P3K→ |
| Two-sided | P1YMCKT→P1YMCKB | Page processing order |
| printing | →P2YMCKT→P2YMCKB→ | rearrangement (for |
| | | 4-cycle engine) |
| | | P1YT→P1MT→P1CT→ |
| | | P1KT→P2YT→P2MT→ |
| | | P1YB→P2YT→P1MB |
| | | →P2KT |
| Collation | P1 (YMVK)→P2 (YMCK) | Page processing order |
| | →P3 (YMCK) | rearrangement |
| Face up FU ———————— [symbol] | | From the last page of |
| | | the job |
| Face down FD ———————— [symbol] | | From the first page of |
| | | the job |
| Instruction on | P1 (YMVK)→P2 (YMCK) | Image positioning on a |
| stapling | →P3 (YMCK) | sheet |
| position | | Image rotation |
| (Finisher) | | Vertical and horizontal |
| | | shift, etc. |

[FIG. 3B]

| Status of output side | Processing of BEP |
|---|---|
| Paper jamming or power failure | Recovery processing |
| | Send non-processed pages in images |

[FIG. 4A]

1: Image forming apparatus

8: User interface

A: RIP processing & controller

B: Generally dedicated

[FIG. 4B]

1: Image forming apparatus

A: High-speed LAN

B: General-purpose one

C: Print file

Number of copies

Two-sided or one-sided printing

Color or monochrome

Combined printing

With or without sorting

With or without stapler

D: Mainly RIP processing

E: System with DFEs to image forming apparatus equal to n:1

[FIG. 4C]

1: Image forming apparatus

A: High-speed LAN

B: Proofer

C: High-speed and high-performance

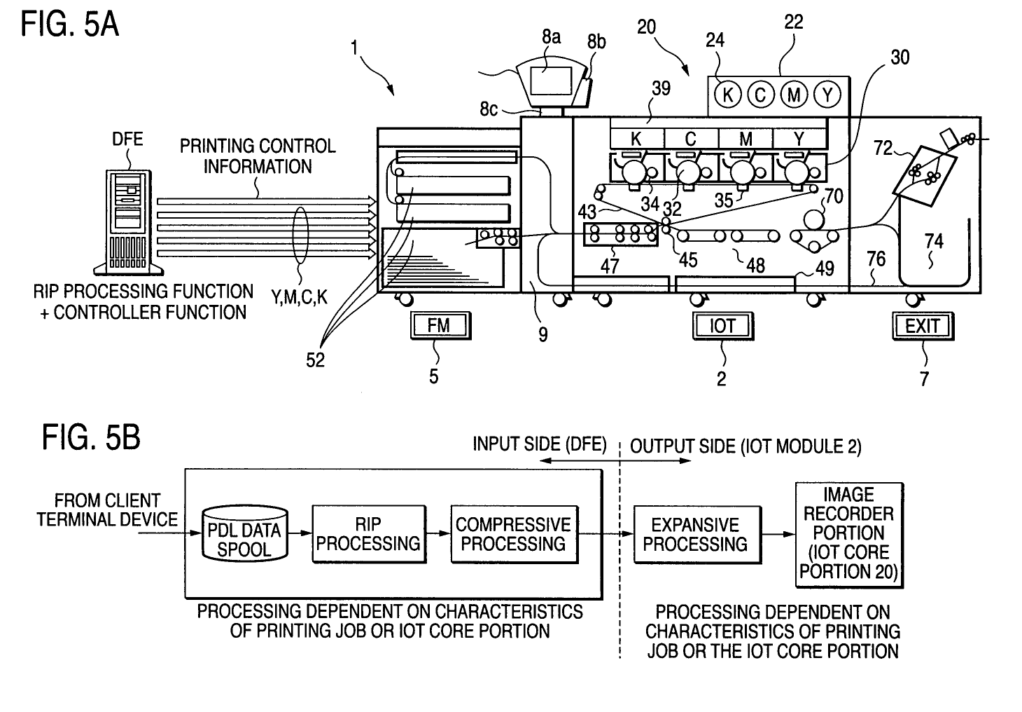

D: System with DFEs to image forming apparatuses equal to n:m

[FIG. 5A]

1: Image forming apparatus

2: IOT module

5: Feed module

7: Output module

9: Coupling module

20: IOT core portion

22: Toner supply portion

30: Printing engine

52: Sheet tray

A: RIP processing function+controller function

B: Printing control information

[FIG. 5B]

A: From client terminal device

B: PDL data spool

C: RIP processing

D: Compressive processing

E: Input side (DFE)

F: Processing dependent on the characteristics of printing job or the IOT core portion

G: Output side (IOT module 2)

H: Expansive processing

I: Image recorder portion (IOT core portion 20)

J: Processing dependent on the characteristics of printing job or the IOT core portion

What is claimed is:

1. An image forming system comprising:
a front-end processor having an image data generation portion for generating image data of each page by processing a printing job, and
a back-end processor, provided corresponding to an image recorder portion for recording an image on a predetermined recording medium, for receiving image data of each page from said front-end processor, sending the image data to said image recorder portion, and controlling said image recorder portion, wherein
said front-end processor generates the image data independent of said image recorder portion, and
said back-end processor includes;
an image storage portion for receiving and storing image data processed by said front-end processor independent of said image recorder portion,
an output format information acquisition portion for receiving information related to an output format desired by a client, and
a printing control portion for providing control to each functional portion in said back-end processor so as to read the image data from said image storage portion, perform processing dependent on said image recorder portion and the output format desired by the client indicated by the information acquired by said output format in formation acquisition portion, and send the image data to said image recorder portion.

2. The image forming system according to claim 1, wherein
said printing control portion controls so as to generate a two-sided image in a sequence dependent on the processing characteristics of said image recorder portion on a condition that said output format information acquisition portion receives information indicative of a two-sided output instruction as information related to the output format desired by the client.

3. The image forming system according to claim 1, wherein
said printing control portion controls so as to perform collation processing in accordance with an exit paper face dependent on the processing characteristics of said image recorder portion on a condition that said output format information acquisition portion receives information indicative of a collation-related instruction as information related to the output format desired by the client.

4. The image forming system according to claim 1, wherein
said printing control portion controls so as to perform stapling positioning processing dependent on the processing characteristics of said image recorder portion on a condition that said output format information acquisition portion receives information indicative of a stapling-related instruction as information related to the output format desired by the client.

5. An image forming system comprising:
a front-end processor having an image data generation portion for generating image data of each page by processing a printing job, and
a back-end processor, provided corresponding to an image recorder portion for recording an image on a predetermined recording medium, for receiving image data of each page from said front-end processor, sending the image data to said image recorder portion, and controlling said image recorder portion, wherein
said front-end processor generates the image data independent of said image recorder portion, and
said back-end processor includes;
an image storage portion for receiving and storing image data processed by said front-end processor independent of said image recorder portion, and
a printing control portion for providing control to each functional portion in said back-end processor so as to read the image data from said image storage portion, perform processing dependent on said image recorder portion, and then send the image data to said image recorder portion, and to perform recovery processing for output jamming dependent on the processing characteristics of said image recorder portion when an output jamming phenomenon is occurred during processing of the printing job.

6. The image forming system according to claim 1, wherein
said front-end processor and said back-end processor transmit an electric signal therebetween via a communications interface independent of said image recorder portion, and
said back-end processor and said image recorder portion transmit an electric signal therebetween via a communications interface dependent on said image recorder portion.

7. Aback-end processor disposed for use between a front-end processor having an imaged at a generation portion for generating image data of each page by processing a printing job and an image recorder portion for recording an image on a predetermined recording medium, said back-end processor for receiving image data of each page from said front-end processor, sending the image data to said image recorder portion, and controlling said image recorder portion, said back-end processor comprising:
an image storage portion for receiving and storing image data processed by said front-end processor independent of processing characteristics of said image recorder portion,
an output format information acquisition portion for receiving information related to an output format desired by a client, and
a printing control portion for controlling to each functional portion in said back-end processor so as to read the image data from said image storage portion, perform processing dependent on said image recorder portion and the output format desired by the client indicated by the information acquired by said output format information acquisition portion, and send the image data to said image recorder portion.

8. The back-end processor according to claim 7, wherein
said printing control portion controls so as to generate a two-sided image in a sequence dependent on the processing characteristics of said image recorder portion on a condition that said output format information acquisition portion receives information indicative of a two-sided output instruction as information related to the output format desired by the client.

9. The back-end processor according to claim 7, wherein
said printing control portion controls so as to perform collation processing in accordance with an exit paper face dependent on the processing characteristics of said image recorder portion on a condition that said output format information acquisition portion receives information indicative of a collation-related instruction as information related to the output format desired by the client.

10. The back-end processor according to claim 7, wherein
said printing control portion controls so as to perform stapling positioning processing dependent on the processing characteristics of said image recorder portion on a condition that said output format information acquisition portion receives information indicative of a stapling-related instruction as information related to the output format desired by the client.

11. Aback-end processor disposed for use between a front-end processor having an imaged at a generation portion for generating image data of each page by processing a printing job and an image recorder portion for recording an image on a predetermined recording medium, said back-end processor for receiving image data of each page from said front-end processor, sending the image data to said image recorder portion, and controlling said image recorder portion,
said back-end processor comprising:
an image storage portion for receiving and storing image data processed by said front-end processor independent of said image recorder portion, and
a printing control portion for controlling to each functional portion in said back-end processor so as to read the image data from said image storage portion, perform processing dependent on said image recorder portion, and send the image data to said image recorder portion, and to perform recovery processing for output jamming dependent on the processing characteristics of said image recorder portion when an output jamming phenomenon occurs during processing of the printing job.

12. The back-end processor according to claim 7, further comprising:
an image editor portion for editing image data read from said image storage portion.

13. The back-end processor according to claim 7, further comprising:
a front-end side interface portion responsible for transmission of an electric signal with said front-end processor by means of a communications interface independent of said image recorder portion, and
an output-side interface portion responsible for transmission of an electric signal with said image recorder portion by means of a communications interface dependent on said image recorder portion.

14. The image forming system according to claim 5, wherein
said front-end processor and said back-end processor transmit an electric signal therebetween via a communications interface independent of said image recorder portion, and
said back-end processor and said image recorder portion transmit an electric signal therebetween via a communications interface dependent on said image recorder portion.

15. The back-end processor according to claim 11, further comprising:
an image editor portion for editing image data read from said image storage portion.

16. The back-end processor according to claim 11, further comprising:
a front-end side interface portion responsible for transmission of an electric signal with said front-end processor by means of a communications interface independent of said image recorder portion, and
an output-side interface portion responsible for transmission of an electric signal with said image recorder portion by means of a communications interface dependent on said image recorder portion.
